(19) United States
(12) Patent Application Publication
(10) Pub. No.: US 2005/0157197 A1
(43) Pub. Date: Jul. 21, 2005

(54) Image photographing apparatus

(75) Inventors: Yong-Seok Bang, Seoul (KR); Young-Ju Yeo, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/036,102

(22) Filed: Jan. 18, 2005

(30) Foreign Application Priority Data
Jan. 20, 2004 (KR) 2004-4142

(51) Int. Cl. H04N 5/222

(52) U.S. Cl. 348/333.06

(57) ABSTRACT

An image photographing apparatus includes a case and a camera lens case unit that is rotatable inside of the case. The camera lens case unit is automatically or manually rotatable. A control unit manually rotates the camera lens unit through a rotation button or automatically rotates the camera lens unit through a signal generated by an attitude sensor, or through a combination thereof The mounting portion of the camera lens case unit is disposed at any one of the corners inside of the body 100 to safely receive the camera lens case unit 200, as well as increasing the photograph range of the image photographing apparatus. Disposing the camera lens case unit within the body of the image photographing apparatus protects the camera lens case unit from external debris and shocks.

### CROSS-REFERENCE TO RELATED APPLICATIONS

This application claims the benefit under 35 U.S.C. § 119(a) of Korean Patent Application No. 2004-04142, filed on Jan. 20, 2004, the entire content of which is hereby incorporated by reference.

### BACKGROUND OF THE INVENTION

1. Field of the Invention

The present invention relates to an image photographing apparatus capable of providing the function of a digital still camera and a digital camcorder, as well as providing a variety of additional entertainment functions.

2. Description of the Related Art

Generally, a digital still camera (DSC) and a digital camcorder are examples of image photographing apparatuses.

A digital still camera converts an image reflected through a lens into a digital signal through a charge-coupled device (CCD) to be stored on a recording medium. Mostly, a hard disk or a memory card is used as the recording medium. In general, the recording medium only has the function of recording and reproducing the still image because of the small-sized capacity of the recording medium. However, recent developments of the recording medium have allowed for recordation and reproduction of a moving clip in a predetermined amount.

In addition, a general digital camcorder includes a lens device, a charge-coupled device, a deck device for recordation and reproduction, and a display device. The image reflected through the lens device is converted into a digital signal. The digital signal is recorded in a magnetic tape mounted to the deck device. Further, the image on the magnetic tape is reproduced through the deck device to be output to the display device. Consumers prefer an image photographing apparatus that is a single product that is easily portable and usable for the form of use as well as being multi-functional. Therefore, a need exists for a digital image photographing apparatus that is adapted to perform a complex function, such as an electronic diary and a game, in addition to recording and reproducing still and moving images, while being small in size and compact.

### SUMMARY OF THE INVENTION

An object of the present invention is to provide an image photographing apparatus that is light-weight and small in size while taking the above-stated matters into consideration.

The image photographing apparatus of the present invention achieving the foregoing objects includes a body having a recording medium and a camera lens case unit adapted to be rotatable inside of the body.

Preferably, the image photographing apparatus also includes a display panel disposed in the body.

Preferably, the image photographing apparatus includes an attitude sensor for sensing the attitude of the body to rotate the camera lens case, a control unit for receiving a signal with respect to the attitude of the body from the attitude sensor, and a driving unit for rotating the camera lens case according to the signal from the control unit.

Preferably, the image photographing apparatus includes a rotation button disposed on the outer side of the body, and a driving unit for rotating the camera lens case in response to a received signal from the rotation button.

Preferably, the image photographing apparatus includes a zoom pad disposed on the outer side of the body for driving a zoom lens in the camera lens case.

Preferably, a mounting portion for mounting a rotatable camera lens case unit is formed in any one of the comers of the body and is adapted to be opened outwardly.

Other objects, advantages and salient features of the invention will become apparent from the following detailed description, which, taken in conjunction with the annexed drawings, discloses preferred embodiments of the invention.

### BRIEF DESCRIPTION OF THE DRAWINGS

The above aspects and features of the present invention will be more apparent by describing certain embodiments of the present invention with reference to the accompanying drawings, in which:

FIG. 1 is a perspective view of an image photographing apparatus according to an embodiment of the present invention;

FIG. 2 is a elevational view in cross section of a camera lens unit according to an embodiment of the present invention;

FIG. 3 is a block diagram illustrating operation of an image photographing apparatus;

FIG. 4 is a perspective view of an image photographing apparatus indicating the rotatability of a camera lens case unit; and

FIGS. 5A and 5B are perspective views of a camera lens case unit rotating in response to an attitude change of an image photographing apparatus.

Throughout the drawings, like reference numbers will be understood to refer to like parts, components and structures.

### DETAILED DESCRIPTION OF EXEMPLARY EMBODIMENTS

An image photographing apparatus according to an embodiment of the present invention is described with reference to the accompanying drawings as follows:

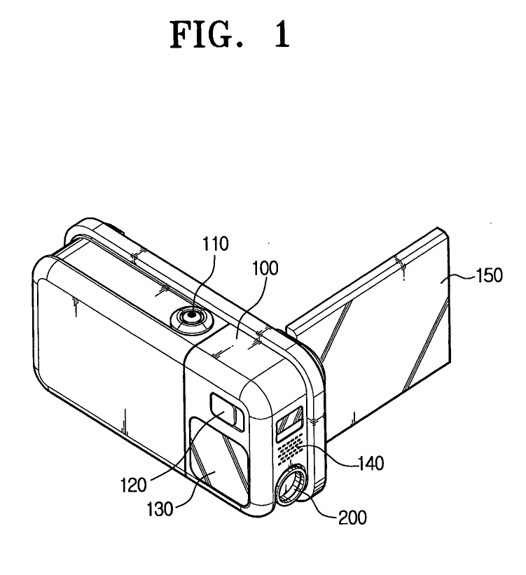

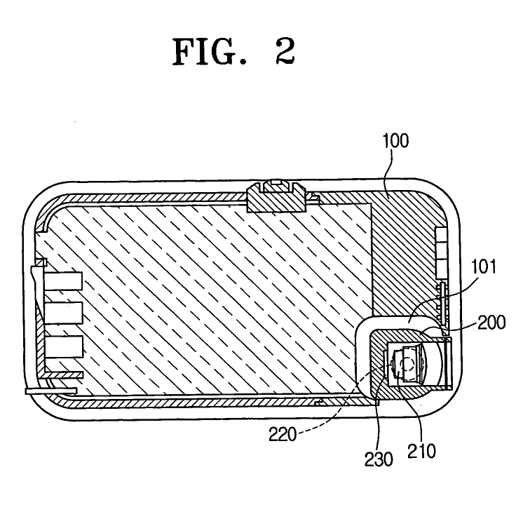

Referring to FIGS. 1 to 3, the image photographing apparatus according to an embodiment of the present invention includes a body 100 and a camera lens case unit 200. The outer side of the body 100 is provided with a recording button 110, a rotation button 120, a zoom pad 130, a voice input/output device 140 and a display panel 150. The inside of the body 100 is provided with a control unit 300, an attitude sensor 320, a recording medium 160, a driving unit 310 and a mounting portion 101 of the camera lens case unit 200. The camera lens case unit 200 is provided with a zoom lens 210, a charge-coupled device (CCD) 230 and a hinge unit 220.

The recording button 110 allows a user to record an image in the image photographing apparatus. The rotation button 200 is an operation button for manually rotating and driving the camera lens case unit 200. The zoom pad 130 is to drive the zoom lens 210 and is generally disposed on an outer side of the body 100. For example, the zoom pad 130 may be similar to a touch pad of a computer notebook. The voice input and output device 140 inputs or outputs voice data and, in general, includes a speaker and a microphone. The display panel 150 outputs moving image data or still image data. Preferably, the display panel 150 is a touch screen adapted to have a predetermined value input with a stylus pen, a finger or a similar device.

The control unit 300 controls the driving unit 310 by calculating an external input value. The control unit includes a central processing unit (CPU). The attitude sensor 320 senses data with respect to the attitude of the image photographing apparatus. An example of a suitable attitude sensor is a gyroscope, although any suitable attitude sensor may be used. In general, the recording medium 160 stores or reproduces image data as input, and generally, a hard disk or a memory card is used as the recording medium 160. The driving unit 310 is disposed inside of the body 100 and is operated in response to signals received from the control unit 300. The mounting portion 101 of the camera lens case unit 200 is disposed at any one of the corners inside of the body 100 so that the camera lens case unit 200 may be safely received. By disposing the camera lens case unit 200 at one corner of the body 100, a rotation angle of the camera lens case unit 200 is increased. Further, such a rotation angle enlarges the photograph range of the image photographing apparatus. In addition, since the costly camera lens case unit 200 is disposed inside of the body 100, it reduces any damage to the camera lens case unit 200 by being protected from any foreign substance or outside impact.

The zoom lens 210 disposed in the camera lens case unit 200 zooms the image photographing apparatus. The CCD 230 is disposed at the back side of a lens unit and converts an image reflected through a lens into a digital signal. The hinge unit 220 is disposed in the camera lens case unit 200 and rotates the camera lens case unit 200 by receiving power from the driving unit 310.

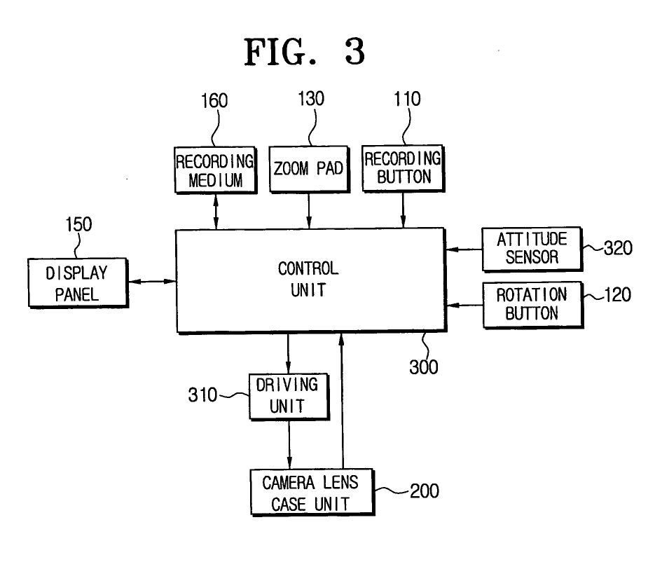

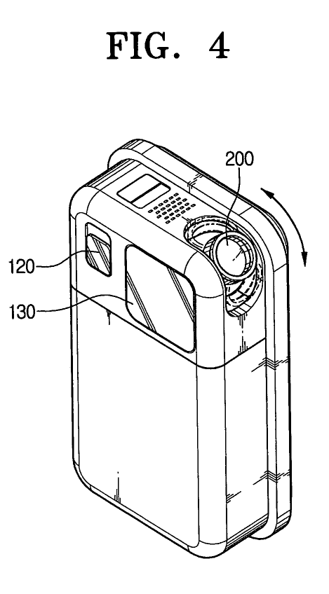

FIG. 4 illustrates the rotation operation of the camera lens case unit 200. The camera lens case unit 200 is able to be manually rotated by the rotation button 120. That is, if a user presses the rotation button 120, a driving signal is sent through the rotation button to the control unit 200, as shown in FIG. 3. At this time, the control unit 300 controls the driving unit 310, which responds to the input driving signal from the control unit and rotates the camera lens case unit 200 accordingly.

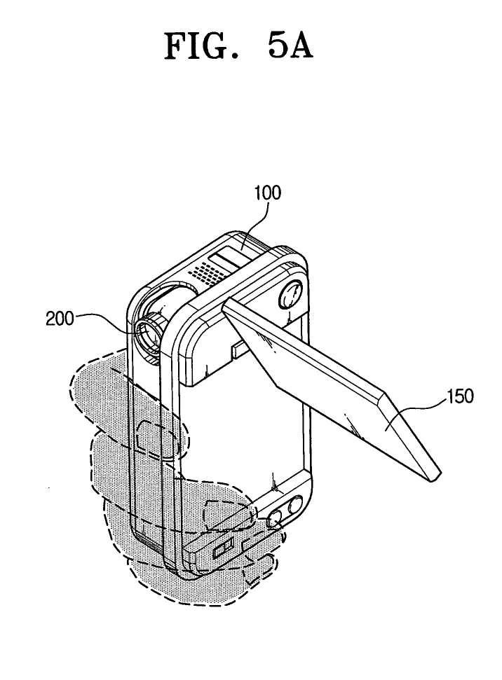

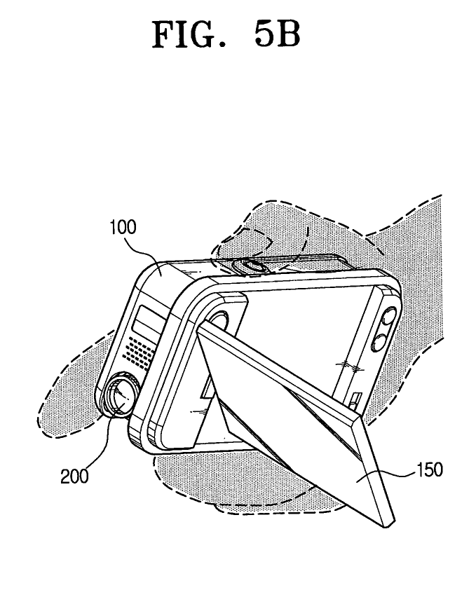

FIGS. 5A and 5B illustrate another embodiment in which the camera lens case unit 200 is automatically rotated by the attitude sensor 320. FIG. 5A shows the the image photographing apparatus used in an “UPRIGHT TYPE” condition, and FIG. 5B shows the image photographing apparatus being used in a “GUN TYPE” condition. If the user uses the image photographing apparatus in the “UPRIGHT TYPE” condition, the data (UPRIGHT TYPE) of the attitude of the body 100 as sensed in the attitude sensor 320, is sent to the control unit 300. The control unit 300 compares the sensed data of the attitude of the body 100 with the predetermined data, and sends a signal to the driving unit 310. The driving unit 310 drives the hinge unit 200 in response to the signal sent from the control unit 300, and rotates the camera lens case unit 200 in accordance with the UPRIGHT TYPE format. The aforementioned principles are identically applied in the case of use in the GUN TYPE format.

As set forth above, since the camera lens case unit 200 is manually and automatically rotatable inside of the body 100 of the image photographing apparatus, operation of the image photographing apparatus is simplified. Further, as the camera lens case unit 200 is rotatable inside of the body 100, it is possible to protect the expensive camera lens case unit 200 from external debris and impacts.

Furthermore, the image photographing apparatus according to an embodiment of the present invention is adapted to have a wireless remote control for a wireless control and a stylus pen that are used to input data on the display panel 150 or the zoom pad 130. The image photographing apparatus may also have the ability to reproduce music in various formats, such as MP3, and to operate various games, such as those downloaded from the Internet, in addition to recording and reproducing images.

As set forth above, the image photographing apparatus of the present invention includes the camera lens case unit that is manually or automatically rotatable according to the use format of a user, thereby offering the user a simple and convenient image photographing apparatus.

Further, since the expensive camera lens case unit is disposed inside of the body of image photographing apparatus, miscellaneous substances are substantially prevented from flowing into the camera lens case unit as well as protecting the camera lens case unit from external shocks.

The foregoing embodiments and advantages are merely exemplary and are not to be construed as limiting the present invention. The present teaching may be readily applied to other types of apparatuses. Also, the description of the embodiments of the present invention is intended to be illustrative, and not to limit the scope of the claims, and many alternatives, modifications, and variations will be apparent to those skilled in the art.

1. An image photographing apparatus, comprising:
a body having a recording medium; and
a camera lens case unit rotatably disposed inside of the body.

2. The image photographing apparatus of claim 1, wherein
a display panel is connected to the body.

3. The image photographing apparatus of claim 1, wherein
an attitude sensor senses the attitude of the body to rotate the camera lens case unit in response thereto;
a control unit to receive a signal with respect to the attitude of the body from the attitude sensor; and
a driving unit to rotate the camera lens case unit in response to the signal from the control unit.

4. The image photographing apparatus of claim 1, wherein
a rotation button is disposed on the outer side of the body; and
a driving unit to rotate the camera lens case unit in response to a signal received from the rotation button.

5. The image photographing apparatus of claim 1, wherein
a zoom pad is disposed on the outer side of the body to drive a zoom lens disposed inside of the camera lens case unit.

6. The image photographing apparatus of claim 1, wherein
a mounting portion adapted to rotatably mount the camera lens case unit is opens outwardly in a corner of the body.

7. An image photographing apparatus, comprising:
a body;
a rotatable camera lens case unit substantially disposed within the body and extends outwardly proximal a comer of the body;
a control unit disposed in the body and connected to the rotatable camera lens case unit to control rotation of the camera lens unit;
an attitude sensor disposed in the body and connected to the control panel to sense attitude of the image photographing apparatus and send a first signal to the control unit to automatically control rotation of the camera lens unit; and
a rotation button disposed on an outer surface of the body to manually send a second signal to the control unit to manually control rotation of the camera lens unit.

8. The image photographing apparatus of claim 7, wherein
a display panel is pivotally secured to the body.

9. The image photographing apparatus of claim 7, wherein
a driving unit is disposed between the control unit and camera lens case unit to drive rotation of the camera lens case unit responsive to a third signal generated by the control unit.

10. The image photographing apparatus of claim 7, wherein
a zoom lens is disposed in the camera lens case unit.

11. The image photographing apparatus of claim 10, wherein
a zoom button is disposed on the body to control the zoom lens.

12. A method of controlling rotation of a camera lens case unit of an image photographing apparatus, comprising the steps of:
sending a first signal to a control unit to rotate the camera lens case unit;
sending a second signal from the control unit to the camera lens case unit;
rotating the camera lens case unit in response to the received second signal.

13. The method of claim 12, further comprising
sending the second signal to a driving unit;
generating a third signal at the driving unit responsive to the second signal;
sending the third signal to the camera lens case unit; and
rotating the camera lens case unit in response to the received third signal.

14. The method of claim 12, further comprising
sensing the attitude of the image photographing apparatus with an attitude sensor; and
generating the first signal in response to the sensed attitude.

15. The method of claim 12, further comprising
manually inputting a desired position of the camera lens case unit; and
generating the first signal in response to the manual input.

16. The method of claim 15, further comprising
manually inputting the desired position of the camera lens case unit by depressing a button on the surface of the image photographing apparatus.

17. The method of claim 12, further comprising
manually inputting the desired position of the camera lens case unit by touching a touch sensitive display screen.
